(19) United States
(12) Patent Application Publication
(10) Pub. No.: US 2007/0207010 A1
(43) Pub. Date: Sep. 6, 2007

(54) Split nut with magnetic coupling

(76) Inventor: Roni Caspi, Los Angeles, CA (US)

Correspondence Address: Christopher J. McDonald;HOFFMAN, WASSON & GITLER, P.C., Suite 522, 2461 South Clark Street, Arlington, VA, 22202, US

(21) Appl. No.: 11/366,610

(22) Filed: Mar. 3, 2006

(51) Int. Cl. F16B 37/08

(52) U.S. Cl. 411/432

(57) ABSTRACT

A split nut has two halves securely fastened to one another by magnets. The magnets may be attached to the nut or the nut itself can be magnetized. The magnets secure the two halves together so that the threads of each half are in alignment and the nut may be moved along a threaded shaft. The nut may be attached to a threaded shaft anywhere along the length of the shaft. The nut has the ability to realign or reform a damaged portion of the threaded shaft. The nut can also be used for tightening, in the manner of a conventional nut. Moreover, the nut can be used for extracting by pushing, as for example in removing steering wheels for a steering column. Also, if provided with a gasket, the nut can stop leaks.

### BACKGROUND OF THE INVENTION

Conventionally, nuts are screwed onto threaded shafts at the end of the shaft. Repeated rotation of the nut causes the nut to move along the shaft to its final desired position. Sometimes this process is not possible. The shaft may run between two pieces, resulting in no available end for the placement of a nut. Also, damage to the threads prevents the entry of the nut on the end fo the shaft.

It is often advantageous to be able to place a nut anywhere along the length of a threaded shaft. The prior art discloses split nuts which may be placed about a threaded shaft. One such disclosure is found in U.S. Pat. No. 2,664,023 (Mugford). Mugford discloses a snap-on split nut having two halves connected by a hinge 32. U.S. Pat. No. 4,657,458 (Woller et al.) discloses an anchor nut for a threaded member having two halves connected together by a thin flexible web or hinge 28 enabling the two sections to be moved from an unfolded position to a folded position. U.S. Pat. No. 5,039,266 (Nagayoshi et al.) discloses a divided nut, having two halves connected together by a hinge 9 or connected by a bayonet coupling.

Split nuts using thin flexible hinges suffer from several problems. Repeated use of the nut will cause metal fatigue in the hinge and eventual breakage. Also, during transportation or use, a hinge may easily become bent or twisted preventing the alignment of the two halves of the nut. Misalignment of the nut causes a misalignment of the threads rendering the nut unusable. Also, the flexible hinge often protrudes outside the perimeter of the nut preventing the application of a tool used for tightening. Other prior art devices, such as disclosed in U.S. Pat. No. 4,572,032 (Kinzler), U.S. Pat. No. 4,132,146 (Uhlig), U.S. Pat. No. 1,803,888 (Basola et al.) and U.S. Pat. No. 6,206,620 (Burns) disclose nuts and dies having hinges more substantial than a thin web of material. These hinges increase the manufacturing cost of the nuts and makes these nuts less likely to be bought and used.

### SUMMARY OF THE INVENTION

A split nut has two halves securely fastened to one another by magnets. The magnets may be attached to the nut or the nut itself can be magnetized. The magnets secure the two halves together so that the threads of each half are in alignment and the nut may be moved along a threaded shaft. The nut may be attached to a threaded shaft anywhere along the length of the shaft. The nut has the ability to realign or reform a damaged portion of the threaded shaft. The nut can also be used for tightening, in the manner of a conventional nut. Moreover, the nut can be used for extracting by pushing, as for example in removing steering wheels for a steering column. Also, if provided with a gasket, the nut can stop leaks.

### BRIEF DESCRIPTION OF THE DRAWINGS

FIG. 1 is a side view of both of the two nut halves;

FIG. 2 is a perspective view of the two nut halves;

FIG. 3 is a perspective view of the two nut halves about a bolt; and

FIG. 4 is a top view of the nut halves connected to one another.

### DETAILED DESCRIPTION OF THE INVENTION

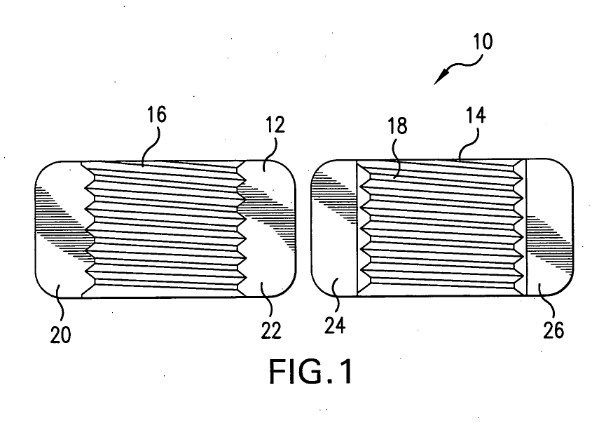

In FIG. 1, the split nut 10 is seen as having a first half 12 and second half 14. The nut maybe made of any material, such as steel or plastic. The first half has end faces 20, 22 and an inner surface with threads 16. The second half 14 has end faces 24, 26, each provided with a magnet. The magnets are secured to the end face in any conventional manner, such as with adhesive. The inner surface of the second half 14 has threads 18. The threads may be any type and chosen based on the application of the nut.

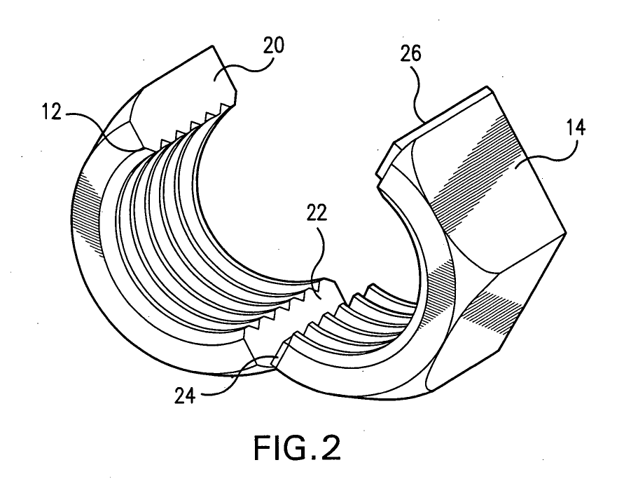

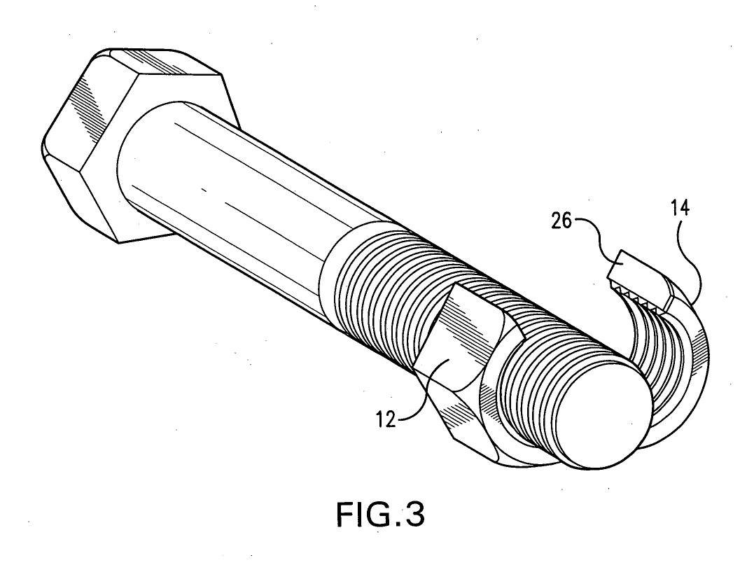

FIG. 2 shows the two halves with the first magnet 24 in alignment with the end face 22 and the second magnet 26 still having to be brought into contact with the end face 20. With the halves being separable but easily joined, the nut can be placed about a threaded shaft without having to start the nut at the end of the shaft and rotating it to its desired position. The nut halves placed about a bolt is readily seen in FIG. 3. In place of the magnet, the region about the end face can be magnetized. In this way, there is no need for a separate magnet as a portion of the nut itself is magnetized. The portion can be the contact surface or can encompass an entire half. Alternatively, only one magnet may be used. This facilitates the removal of the nut from the bolt if the need arises for any reason. It may be difficult to separate the two halves from each other while the nut is attached to the bolt when two magnets are used.

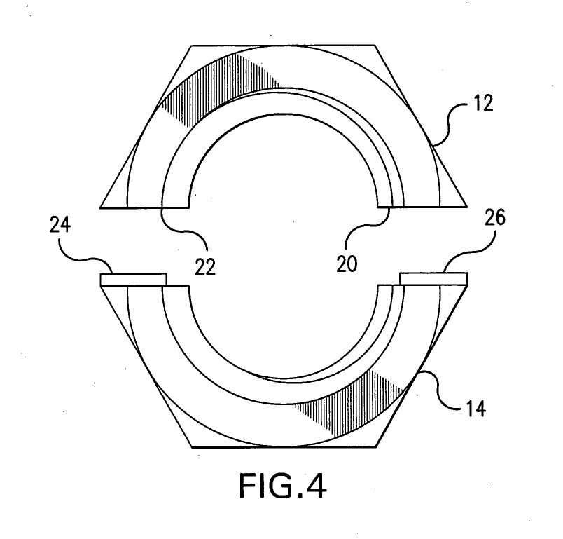

FIG. 4 shows the two halves joined to one another. Once joined, the threads are aligned to form a helical path mating with the threads. The outer surface has a conventional hexagonal shape to receive a tightening tool, such as a wrench or socket. The outer surface of the split nut can have any desired shape for its application. Once joined, the two halves 12, 14 are securely held to one another to function as a conventional one piece nut. The nut can be used for tightening by securely holding its place along a desired location on a threaded shaft or can be used to reform threads on the bolt.

While a preferred embodiment has been described, variations and modifications would be apparent to one of ordinary skill in the art. For instance, each half of the nut may have one magnet with that end face mating with the end face of the other half not having a magnet. Also, the magnets 24, 26 may be held within recesses in the end face so that once the two halves are joined, the magnets are not visible.

I claim:

1. A nut comprising
a first half having an outer surface, an inner surface, a top surface, a bottom surface, a first end face and a second end face,
a second half having an outer surface, an inner surface, a top surface, a bottom surface, a first end face and a second end face,
a magnetic coupler joining said first and second halves.

2. The nut of claim 1, wherein
said outer surface of said first half and said second half each have three sides.

3. The nut of claim 1, wherein
said inner surface of said first half and said second half each have threads.

4. The nut of claim 1, wherein
said magnetic coupler comprises
a first magnet attached to said first half first end face, and
a second magnet attached to said first half second end face.

5. The nut of claim 1, wherein said magnetic coupler is a single magnet.
